(19) United States
(12) Patent Application Publication
(10) Pub. No.: US 2014/0224990 A1
(43) Pub. Date: Aug. 14, 2014

(54) METROLOGY AND METHODS FOR DETECTION OF LIQUID

(71) Applicants: Kip P. Stevenson, Portland, OR (US); Pooya Tadayon, Portland, OR (US); Warren S. Crippen, Aloha, OR (US)

(72) Inventors: Kip P. Stevenson, Portland, OR (US); Pooya Tadayon, Portland, OR (US); Warren S. Crippen, Aloha, OR (US)

(21) Appl. No.: 13/976,432

(22) PCT Filed: Apr. 27, 2012
(86) PCT No.: PCT/US12/35670

§ 371 Date: Jun. 26, 2013

(51) Int. Cl. G01N 21/59

(52) U.S. Cl. CPC G01N 21/59
USPC 250/338.5; 250/372; 250/393; 250/565

(57) ABSTRACT

One embodiment relates to an apparatus comprising a light source adapted to transmit light through a liquid, and a detector adapted to detect an intensity of the light after it passes through the liquid. The apparatus may also include a device to process data relating to the intensity of the infrared light and compare the processed data to predetermined control data. The apparatus may also include a controller adapted to transmit a signal to a liquid dispenser if the processed data differs from the control data by a predetermined amount. The light may be selected from the group consisting of ultraviolet, visible, infrared, and microwave light. Other embodiments are described and claimed.

### BACKGROUND

Current methods to determine information relating to the dispensing of a liquid onto a surface in integrated circuit device manufacturing include several approaches. One method uses liquid chromatography paper to wick up a dispensed drop on a test unit and the wick height is compared to a calibrated height scale. Another method uses an analytical microbalance (scale) to measure the tare weight of a dispensed liquid droplet on a device and determining if the weight is within a proper range. Neither method is considered accurate in the microliter regime or capable of being implemented in-situ to measure the volume of thousands of dispense events per hour.

### BRIEF DESCRIPTION OF THE DRAWINGS

Embodiments are described by way of example, with reference to the accompanying drawings, which are not drawn to scale.

FIG. 1 is a view of an apparatus for in-situ determination of information about a dispense liquid, in accordance with certain embodiments.

FIG. 2 is a flow chart of operations in accordance with certain embodiments.

### DETAILED DESCRIPTION

In order to show features of various embodiments most clearly, the drawings included herein include representations of various electronic and/or mechanical devices. The actual appearance of the fabricated structures may appear different while still incorporating the claimed structures of the illustrated embodiments. Moreover, the drawings may show only the structures necessary to understand the illustrated embodiments. Additional structures known in the art have not been included to maintain the clarity of the drawings.

Certain embodiments relate to devices and methods, including an apparatus including a light emitting device, a detector, a data acquisition device, and a process control device. The light emitting device and detector are configured and positioned so that the light emitting device transmits a signal through a liquid being dispensed onto a surface, and is detected after passing through the liquid by the detector. The data is acquired and processed and information including, but not limited to, the volume and/or mass of the liquid being dispensed onto the surface in a given time, may be determined. The process control device may then be used to control the liquid dispensing apparatus to modify the liquid dispensing if necessary. The operations may in certain embodiments be carried out in-situ during device manufacturing or during testing.

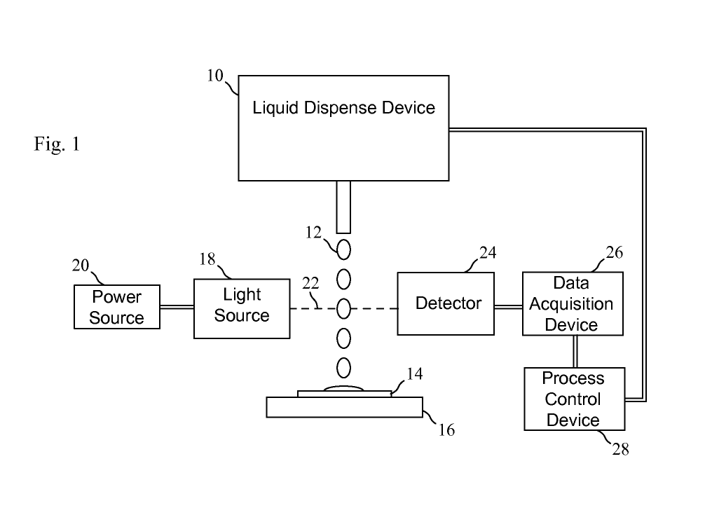

FIG. 1 is a view illustrating an apparatus that is used to detect and obtain information about a liquid dispensed from a liquid dispense device 10 that dispenses a liquid 12 onto a device 14 on a substrate 16, in accordance with certain embodiments. As illustrated in FIG. 1, the liquid 12 may be dispensed as one or more droplets. The liquid may also be dispensed in other forms, for example, in the form of a stream, a mist, or a spray. In the embodiment illustrated in FIG. 1, the light source 18 may be an infra-red (IR) device such as an IR light emitting diode (LED), powered by power source 20. Such IR LED devices are readily available. The IR LED emits IR light 22 through which the liquid droplets 12 pass. A detector 24 such as an IR photodiode detector may be positioned on the other side of the liquid 12 from the light source 18. A data acquisition device 26 received the signal from the detector 24. The data acquisition device 26 may include a signal processing computer to process the data. A process control device 28 uses information from the data acquisition device 26 to control the liquid dispense device 10. Certain of the devices may be modified or combined in certain embodiments. For example, in certain embodiments some or all of the data acquisition and processing may be carried out by circuitry on the detector. In another example, the data acquisition device and process control device may be part of a single device that processes data and transmits a control signal. Other modifications are also possible.

In certain applications the liquid dispense device 10 will be used to dispense a liquid 12 that is aqueous. Water has a strong IR absorbance at 1450 nm and 3050 nm, which correspond to excitation of the 2V1+2V3 symmetric and asymmetric stretch vibration combination band and the V1 symmetric stretch vibration band, respectively. This principle may be utilized to detect the presence of a liquid droplet (or stream, mist, or spray) when passing between the light source 18 and the detector 24. In certain embodiments, the light source 18 is capable of radiating

Near IR to Mid IR wavelengths (e.g., 750 nm to 8000 nm), in a narrow band or broad band range, and the detector 24 has sufficient response to detect such frequencies.

Water will absorb an amount of the IR light, thus reducing the intensity measured at the detector 24. The detector 24 detects the light and generates a voltage proportional to the light detected. The voltage is measured as a function of time while the liquid is being detected. The voltage versus time signal is normalized by the voltage generated by the photodetector when there is no'liquid being detected. Beer's Law relates the voltage to the molecular absorption (Abs=−log(Vₜ/V₀)) where Abs equals absorption, V₁ equals voltage at a particular time, and V₀ equals the voltage of the photodetector when no liquid is detected. In addition, (Abs=e*b*C) where e is the molar extinction coefficient, b is the optical length of the incident light (the distance between the light source and the photodetector), and C is the molar concentration. One can relate the quantity (b*C) to the volume and/or mass of the liquid droplet, as water molar extinction at 1450 nm or 3050 nm is known, as is the molar concentration of H₂O (55.345 moles/L). Integration of the time-resolved IR absorption (JR detector voltage (Vₜ) vs. t) is directly proportional to liquid volume or mass. The data acquisition device 26 may be used for the data calculations, and may include a high sample rate data acquisition system and signal processing computer. For a dispense condition where droplets are dispensed, an independent calibration curve relating absorption versus time to dispensed volume (or mass) can be performed to determine the droplet quantity, which is the basis of the metrology. A calibration approach is to vary the dispense time for constant flow rate conditions and determine the dispensed mass independently. A correlation between the measured integrated absorption for each dispense time and dispensed mass can be performed. The linear “best fit” calibration curve equation allows for direct conversion of measured integrated absorption to calculated mass for given set of dispense conditions (flow rate, dispense time, etc.). A statistical process control scheme can be developed to determine dispense process control limits for dispense quantities of interest thus providing a method to detect and respond in real time to alter the dispense process in real time using the process control device 28 when a value outside of the control limits is obtained. Changes to the dispense process may include, but are not limited to, stopping the process, increasing the flow rate, decreasing the flow rate, changing the fluid concentration, and changing the fluid physical properties such as, for example, viscosity and density.

While certain embodiments are described has being able to detect IR absorption of aqueous solutions (e.g., water and glycol-water) solutions, embodiments may be adapted to detect and determine dispensing profiles of non-aqueous fluids or materials by selection of appropriate light and detector devices in order to target chemically-specific electronic, vibrational, and/or rotational absorptions covering a variety of ranges of the electromagnetic spectrum. Certain embodiments utilize devices in the ultraviolet (UV), visible, and infrared (IR) ranges of the electromagnetic spectrum.

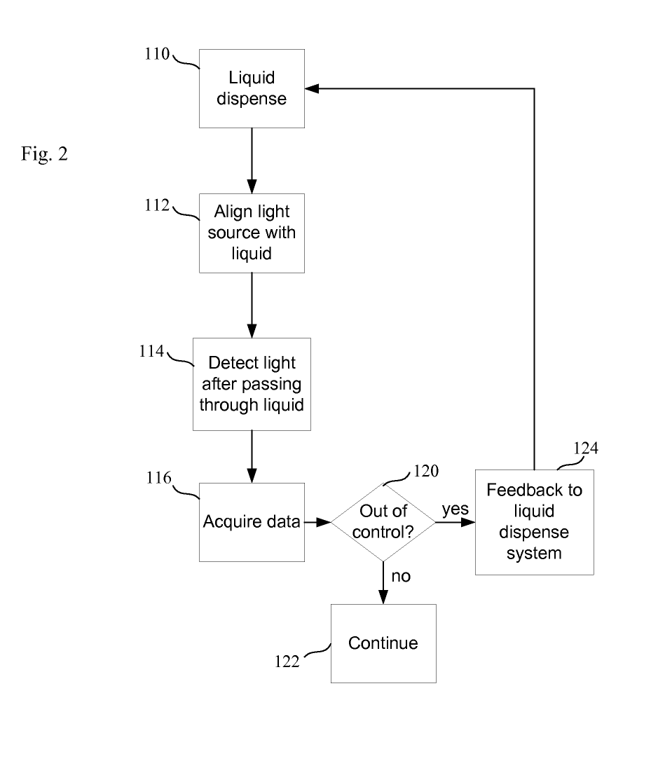

FIG. 2 illustrates a flow chart of operations that ma_{y} be carried out in accordance with certain embodiments. Box 110 is dispensing a liquid to be detected. Examples of dispensing a liquid include, but are not limited to, dispensing a thermal interface material onto a device during testing or during processing, dispensing an underfill material onto a device during processing, and dispensing a flux. Such materials dispensed may include, but are not limited to, aqueous liquids, non-aqueous liquids, polymers, metals, glasses, and ceramics. Embodiments may find application in a wide variety of processing operations in addition to those listed above. The liquid being detected may in certain situations be dispensed as droplets, while in other situations the liquid being detected may be dispensed as a spray, fine mist, or stream. Box 112 is aligning a light source of electromagnetic radiation that will intersect with the liquid being dispensed. As illustrated in FIG. 1, the light source may in certain embodiments be an IR light emitting diode (LED). Other wavelengths of radiation may also be used. Box 114 is positioning the detector and detecting the light after it has passed through the liquid. As illustrated in FIG. 1, the detector may be a photodiode that can detect IR. The type of detector used will generally be dependent on the type of light source of electromagnetic radiation used.

Box 116 is acquiring data relating to the light passing through the liquid. A data acquisition device that may include, for example, a computer processor, may be used to acquire and process the data from the detector and determine, for example, the volume and/or mass of the liquid being dispensed. The processed data may then be compared with a known control data range. Box 120 is determining if the determined information falls outside of the control data range. If no, then the operation continued, as in Box 122. If yes, then a control command is provided to the liquid dispense device to perform the appropriate change to the dispensing, for example, stopping, increasing, or decreasing the flow rate.

Certain embodiments enable determination of information about a dispensed liquid such as, for example, a liquid droplet mass and/or volume in-situ of a liquid dispense system used in device manufacturing and test processes. Current procedures to determine whether proper liquid dispense is taking place utilize quantitative assessment processes that are not in-situ and not well suited to enable proper process control measures in a high volume manufacturing environment.

The ability to control the liquid dispense in-situ leads to significant advantages including, but not limited to, increased quality control, higher yield, and less waste. For example, in a test process, the application of too little liquid can cause mis-classification of CPU performance during the test, and application of too much fluid can cause cosmetic staining quality concerns, both of which negatively impact the test bin split and yield.

Certain embodiments also offer advantages relating to compact size, low cost, and low power consumption. For example, an IR LED may have a diameter of, for example, about 4 mm in diameter with various view half angles of from 7 degrees to 50 degrees. Photodiode diameters may have a diameter of, for example, 0.6 mm to several mm. These small sizes enable the components to be positioned close to a dispense nozzle in tight spaces. In certain embodiments, appropriate signals may be obtained over small distances between the LED and the photodiode of approximately 1 to 10 mm. In addition, the components used in various embodiments are relatively low cost and readily available. Low power components may also be used in various embodiments, for example, an LED may use a power supply of about 1 volt, and low voltage signal processing circuitry may be used. In one example, an LED may operate from 1 to 1.4 volts, and a photodiode may measure hundreds of mA or mV for a 2 mW LED. In addition, the data acquisition may be carried out using readily available data acquisition cards. For high volume test metrology a microcontroller/time integration circuit can be obtained or built to analyze several signals. The microcontroller may also interface to standard machine control algorithms.

It should be appreciated that many changes may be made within the scope of the embodiments described herein.

Terms such as “first”, “second”, and the like, if used herein, do not necessarily denote any particular order, quantity, or importance, but are used to distinguish one element from another. Terms such as “top”, bottom”, “upper”, “lower”, and the like, if used herein, are used for descriptive purposes only and are not to be construed as limiting. Embodiments may be manufactured, used, and contained in a variety of positions and orientations.

In the foregoing Detailed Description, various features are grouped together for the purpose of streamlining the disclosure. This method of disclosure is not to be interpreted as reflecting an intention that the claimed embodiments of the invention require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate preferred embodiment.

While certain exemplary embodiments have been described above and shown in the accompanying drawings, it is to be understood that such embodiments are merely illustrative and not restrictive, and that embodiments are not restricted to the specific constructions and arrangements shown and described since modifications may occur to those having ordinary skill in the art.

What is claimed:

1. An apparatus comprising:
an infrared light source adapted to transmit infrared light through a liquid;
a detector adapted to detect an intensity of the infrared light after it passes through the liquid; and
a device to process data relating to the intensity of the infrared light and compare the processed data to predetermined control information.

2. The apparatus of claim 1, further comprising a controller adapted to transmit a signal to a liquid dispenser if the processed data differs from the predetermined control information by a predetermined amount.

3. The apparatus of claim 1, wherein the infrared light source comprises a light emitting diode.

4. The apparatus of claim 1, wherein the detector comprises a photodiode.

5. An apparatus comprising:
a light source adapted to transmit light through a liquid;
a detector adapted to detect an intensity of the light after it passes through the liquid; and
a device to process data relating to the intensity of the light and compare the processed data to predetermined control data;
wherein the light is selected from the group consisting of ultraviolet, visible, infrared, and microwave light.

6. The apparatus of claim 5, further comprising a controller adapted to transmit a signal to a liquid dispenser if the processed data differs from the control data by a predetermined amount;

7. The apparatus of claim 5, wherein the light is ultraviolet light.

8. The apparatus of claim 5, wherein the light is visible light.

9. The apparatus of claim 5, wherein the light is microwave light.

10. The apparatus of claim 5, wherein the light source comprises a light emitting diode.

11. The apparatus of claim 5, wherein the light source comprises an infrared light emitting diode.

12. The apparatus of claim 5, wherein the detector comprises a photodiode.

13. A method comprising:
providing a liquid from a liquid dispenser;
transmitting a light through the liquid the light selected from the group consisting of ultraviolet, visible, infrared, and microwave light;
detecting an intensity of the light after the transmitting the light through the liquid;
determining information about the liquid from the intensity of the light;
comparing the information about the liquid with predetermined control information; and
transmitting a signal to the liquid dispenser if the information differs from the predetermined control information by a predetermined amount.

14. The method of claim 13, wherein the transmitting a signal to the liquid dispense includes a signal to modify a flow rate of the liquid dispenser.

15. The method of claim 13, wherein the light is ultraviolet light.

16. The method of claim 13, wherein the light is visible light.

17. The method of claim 13, wherein the light is infrared light.

18. The method of claim 13, wherein the light is microwave light.

19. The method of claim 13, comprising using a light emitting diode for the transmitting the light.

20. The method of claim 13, comprising using a photodiode for the detecting the intensity of the light.
